(19) United States
(12) Patent Application Publication
(10) Pub. No.: US 2019/0126553 A1
(43) Pub. Date: May 2, 2019

(54) CLEANING APPARATUS

(71) Applicants: Andreu OLIVER, Sant Cugat del Valles (ES); Xavier ALONSO, Sant Cugat del Valles (ES); Marc NICOLAU, Sant Cugat del Valles (ES); Ismael CHANCLON, Sant Cugat del Valles (ES); HEWLETT-PACKARD DEVELOPMENT COMPANY, L.P., Houston, TX (US)

(72) Inventors: Andreu Oliver, Sant Cugat del Valles (ES); Xavier Alonso, Sant Cugat del Valles (ES); Marc Nicolau, Sant Cugat del Valles (ES); Ismael Chanclon, Sant Cugat del Valles (ES)

(73) Assignee: HEWLETT-PACKARD DEVELOPMENT COMPANY, L.P., Houston, TX (US)

(21) Appl. No.: 16/095,656

(22) PCT Filed: Jun. 30, 2016
(86) PCT No.: PCT/EP2016/065351

§ 371 Date: Oct. 22, 2018

(51) Int. Cl. B29C 64/35; B08B 1/04; B08B 5/04; B33Y 40/00

(52) U.S. Cl. CPC B29C 64/35; B33Y 40/00; B08B 5/04; B08B 1/04

(57) ABSTRACT

A build material cleaning structure (150) for use in an additive manufacturing system. The build material cleaning structure comprises: a tubular portion defining a channel to pneumatically transport a build material; a rotatable head portion located at least in part within the tubular portion and comprising a cleaning element (152) extending away from an open end of the tubular portion; and a rotor assembly located within the tubular portion and mechanically coupled to the rotatable head portion to generate a torque to drive the rotatable head portion in a rotary motion in response to an airflow in the channel; wherein the rotatable head portion is rotatable in a plane that is substantively orthogonal to the airflow in the channel.

### BACKGROUND

Additive manufacturing techniques such as three-dimensional (3D) printing, relate to techniques for making 3D objects of almost any shape from a digital 3D model through additive processes, in which 3D objects are generated on a layer-by-layer basis under computer control. A large variety of additive manufacturing technologies have been developed, differing in build materials, deposition techniques and processes by which the 3D object is formed from the build material. Such techniques may range from applying ultraviolet light to photopolymer resin, to melting semi-crystalline thermoplastic materials in powder form, to electron-beam melting of metal powders.

Additive manufacturing processes usually begin with a digital representation of a 3D object to be manufactured. This digital representation is virtually sliced into layers by computer software or may be provided in pre-sliced format. Each layer represents a cross-section of the desired object, and is sent to an additive manufacturing apparatus, that in some instances is known as a 3D printer, where it is built as a new layer or upon a previously built layer. This process is repeated until the object is completed, thereby building the object layer-by-layer. While some available technologies directly print material, others use a recoating process to form additional layers that can then be selectively solidified in order to create the new cross-section of the 3D object.

The build material from which the object is manufactured may vary depending on the manufacturing technique and may for example comprise powder material, paste material, slurry material or liquid material. The build material is usually provided in a source container from where it is to be transferred to the building area or building compartment of the additive manufacturing apparatus where the actual manufacturing takes place.

### DRAWINGS

Various features of the present disclosure will be apparent from the detailed description which follows, taken in conjunction with the accompanying drawings, wherein:

FIG. 1 is a schematic diagram showing an example of a build material management system.

FIG. 2A is a schematic diagram showing an example of a build material cleaning structure viewed in section.

FIG. 2B is a schematic diagram showing an example of a build material cleaning structure viewed from viewpoint A of FIG. 2A.

FIG. 2C is a schematic diagram showing an example of a build material cleaning structure viewed from viewpoint B of FIG. 2A.

FIG. 3 is a schematic diagram showing an example of a build material cleaning structure viewed in section.

FIG. 4 is a schematic diagram showing an example of a build material cleaning structure viewed in section.

FIG. 5 is a schematic diagram showing an example of a build material cleaning structure viewed in section.

FIG. 6 is a flow chart showing an example of a method of collecting build material.

### DESCRIPTION

Three-dimensional (3D) objects can be generated using additive manufacturing techniques. With some 3D printing techniques the objects may be generated by solidifying portions of successive layers of build material. The build material can be powder-based and the properties of generated objects may be dependent upon the type of build material and the type of solidification. In some examples, solidification of the powder material is enabled using a liquid fusing agent. In other examples, solidification may be achieved by using a chemical binding agent. In certain examples, a fusing agent is applied to the build material, and a suitable amount of a fusing energy is applied to causes the build material to fuse and solidify. In other examples, other build materials and other methods of solidification may be used. In certain examples, the build material includes paste material, slurry material or liquid material.

In one example the build material used in the additive manufacturing process of this disclosure is a powder-based build material. Suitable powder-based build materials may include at least one of polymers, crystalline plastics, semi-crystalline plastics, polyethylene (PE), polylactic acid (PLA), acrylonitrile butadiene styrene (ABS), amorphous plastics, Polyvinyl Alcohol Plastic (PVA), Polyamide, thermo(setting) plastics, resins, transparent powders, colored powders, metal powder, ceramics powder such as for example, glass particles, and/or a combination of at least two of these or other materials, wherein such combination may include different particles each of different materials, or different materials in a single compound particle. Examples of blended build materials include alumide, which may include a blend of aluminum and polyamide, multi-color powder, and plastics/ceramics blends. Blended build material may comprise two or more different respective average particle sizes.

A particular batch of build material for use in an additive manufacturing process may be “virgin” build material or “used” build material. Virgin build material should be considered to be build material which has not been used in an additive manufacturing process. An unopened supply of build material as supplied by a build material manufacturer therefore contains virgin build material. By contrast, used build material is build material which has previously been supplied to a 3D printing system for use in an additive manufacturing process but not incorporated into a 3D printed article. In this respect, it will be understood that not all of the build material supplied to a 3D printing system for use in an additive manufacturing process may be used and/or incorporated into a 3D printed article. For example, used build material may refer to a build material to which a fusing energy has been applied but, in the absence of a fusing agent, has not fused or solidified. Such build material may also be referred to as “unfused” build material. At least some of the unfused build material supplied to a 3D printing system for use in an additive manufacturing process may be suitable for reuse in a subsequent additive manufacturing process.

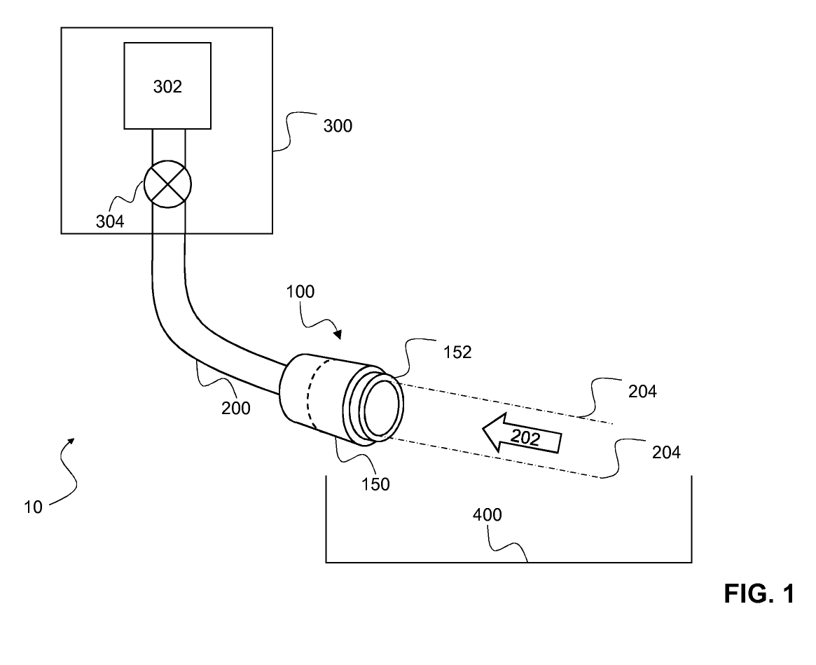

FIG. 1 is a schematic diagram showing an example of a build material management system 10 for collection of build material from a work area 400. For example, the build material management system 10 may be used to collect unfused build material from the surface of a 3D printed article (not shown) located in the work area 400 and/or any unfused build material present in the work area 400. For example, the 3D printed article may sit in a bed of unfused build material, therefore necessitating bulk collection of unfused build material from the bed and also unfused build material from the surface of the 3D printed article. The build material management system 10 may form a component of an additive manufacturing system comprising a 3D printer (not shown).

The build material management system 10 includes a nozzle structure 100 to collect unfused build material from the work area 400. The nozzle structure 100 is connected to a build material storage apparatus 300 by a flexible hose 200. The build material storage apparatus 300 includes a vacuum source 304, such as a vacuum pump or fan, to generate an airflow in the flexible hose 300 and the nozzle structure 100. The airflow is used to draw or aspirate the unfused build material from the work area 400 into the nozzle structure 100, in the direction shown by arrow 202. Once the unfused build material has been drawn into the nozzle structure 100, it is pneumatically transported through the nozzle structure 100 and the flexible hose 200 to the build material storage apparatus 300 for storage in a tank or reservoir 302. Once collected, the unfused build material may be reused in the manufacture of further 3D printed articles.

The nozzle structure 100 includes a build material cleaning structure 150, which is provided to mechanically agitate or disperse the unfused build material on the surface of a 3D printed article. This mechanical agitation promotes efficient aspiration of the unfused build material by the nozzle structure 100 for pneumatic transport to the build material storage apparatus 300. To provide this agitation, the build material cleaning structure 150 includes a cleaning element 152 which extends away from an open end of the nozzle structure 100 and rotates in response to the airflow through the nozzle structure 100 (i.e. a rotatable cleaning element). Rotation of the cleaning element 152 is provided by one or more aerodynamic elements (not shown) which are configured to generate a torque in response to the airflow in the nozzle structure 100.

In use, the nozzle structure 100 may be brought into close proximity with the 3D printed article, such that the cleaning element 152 is in a position to mechanically agitate unfused build material on the surface of the 3D printed article by its rotation. This mechanical agitation may, for example, be used to break up compacted build material present on the surface of the 3D printed article.

In some examples, the cleaning element 152 is configured to rotate about an axis that is substantively parallel to the direction of airflow 202 through the nozzle structure 100. In other words, the cleaning element 152 is configured to rotate in a plane that is substantively orthogonal to the direction of the airflow 202 through the nozzle structure 200. For example, the cleaning element 152 may be configured to rotate in a plane that extends across an open end of the nozzle structure 100, whilst providing an opening for aspiration of the unfused build material into the nozzle structure 100. This arrangement ensures that cross-sectional profile of the cleaning element 152 is contained within the cross-sectional profile of the nozzle structure 152, thereby providing a relatively compact build material cleaning structure 150, which is particularly suitable for collection of build material from 3D printed articles.

In a similar manner, rotation of the cleaning element 152 about an axis that is substantively parallel to the airflow direction 202 minimizes or reduces the dissipation of the airflow 202 profile relative to that which would be caused by a cleaning element rotating about an axis transverse to the airflow 202. Thus, the cleaning structure 150 provides a relatively focused airflow (indicated by dashed lines 204) which is particularly suitable for targeted collection of unfused build material from a 3D printed article.

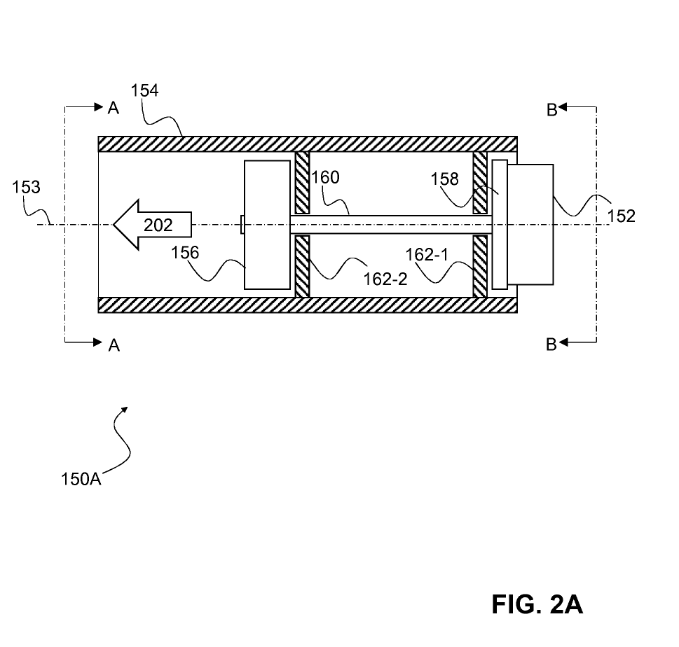

FIG. 2A is a schematic diagram showing a sectional view of an example of a build material cleaning structure 150A for use in the system 10 of FIG. 1. In this example, the build material cleaning structure 150A comprises a tubular portion 154 (e.g. a cylindrical tubular portion) and a rotatable head portion 158 on which the cleaning element 152 is mounted. The internal surface of the tubular portion 154 defines a channel for the pneumatic transport of build material in the direction indicated by arrow 202. The rotatable head portion 158 is located at least in part within the tubular portion and is rotatable around an axis which is coaxial with the central axis 153 of the tubular portion 154. The cleaning element 152 extends from a leading face of the rotatable head portion 158 in a direction which is parallel to the central axis 153 of the tubular portion 154, such that at least a portion of the cleaning element 152 extends away from an open end of the tubular portion 152 to contact the 3D printed article when in use.

In this example, the build material cleaning structure 150A includes a rotor assembly 156 located within the tubular portion 154 and rotatable around the central axis 153 of the tubular portion 154. The rotor assembly 156 includes one or more aerodynamic elements (not shown) which are configured to generate a torque to drive the rotatable head portion 158 in a rotary motion in response to an airflow 202 in the channel. In some examples, the one or more of aerodynamic elements may be provided by a plurality of turbine blades which are configured to generate the torque in response to the airflow 202.

The rotor assembly 156 and the rotatable head portion 158 are mechanically coupled by a shaft 160 which is coaxial with the central axis 153 of the tubular portion 154. The shaft 160 applies the torque generated by the rotor assembly 156 to the rotatable head portion 158 to drive the rotatable head portion 158 and the attached cleaning element 152 in a rotary motion. As discussed above in relation to FIG. 1, the cleaning element 152 rotates to mechanically agitate or disperse the unfused build material on the surface of the 3D printer article, to promote efficient aspiration by the nozzle structure 100 for pneumatic transport to the build material storage apparatus 300.

The shaft 160 may be supported within the tubular portion by a support structure 162 which allows rotation of the shaft whilst presenting minimal obstruction or resistance to the airflow 202 in the tubular portion 154. In the example shown in FIG. 2, the shaft 160 is supported by a support structure 162 comprising a first elongate support member 162-1 and a second elongate support member 162-2. The first elongate support member 162-1 and the second elongate support member 162-2 are separated from each other along the central axis 153 and extend across a diameter of the tubular portion 152 to intersect the central axis 153. The first elongate support 162-1 and the second elongate support 162-2 provide respective bearing surfaces (e.g. plain bearings) to rotatably support the shaft 160 with respect to the tubular portion 154.

FIG. 2B is a schematic diagram showing the rotor assembly 156 of the build material cleaning structure 150A, viewed in direction A of FIG. 2A. The rotor assembly 156 includes a plurality of turbine blades 156-N (where N is a numeral referring to the particular turbine blade) which extend from and are circumferentially distributed about central point that is coincident with central axis of the tubular portion 154. The turbine blades 156-N are configured to exert a torque on the shaft 160 in the direction indicated by arrow 180, in response to airflow 202 in the channel defined by the tubular section 154. As shown in FIG. 2B, the second elongate support 162-2 extends across a diameter of the tubular portion 154 and is configured to occupy a relatively small fraction of the cross-sectional area of the tubular portion 154. In this manner, the second cross support 162-2 presents minimal resistance to airflow in the channel and does not significantly affect the efficiency with which build material can be pneumatically transported to the build material storage apparatus 300.

FIG. 2C is a schematic diagram showing the cleaning element 152 and rotatable head portion 158 of the build material cleaning structure 150A, viewed in direction B of FIG. 2A. The cleaning element 152 comprises a plurality of filament bundles 152-M (where M is a numeral referring to the particular filament bundle) which extend from a leading surface of the rotatable head portion 158. Each filament bundle 152-M comprises a plurality of filaments to agitate the build material. In some examples, the plurality of filaments may be formed from a resilient material such as nylon. Further, to prevent or reduce the build-up of build material on the surface of the cleaning element 152, the filaments may formed from or treated with an anti-static material, such as a conductive material that may be connectable to electrical ground, to reduce the buildup of a static charge on the surface of the filaments due to friction. Each bundle of filaments 152-M may be retained in a recessed hole or pocket in the rotatable head portion 158 (not shown) using glue or any other suitable retaining means.

The rotatable head portion 158 may comprises one of more openings 159 to allow pneumatic transport of the build material through the rotatable head portion into the channel defined by the tubular portion 154. In the example shown in FIG. 2C, the rotatable head portion 158 comprises an outer annular section and a transverse section which extends across a diameter of the annular section to define two semi-circular openings 159 either side of the transverse section. The plurality of filament bundles 152-M are circumferentially distributed around the annular section and radially across the transverse section to provide effective agitation of compacted build material.

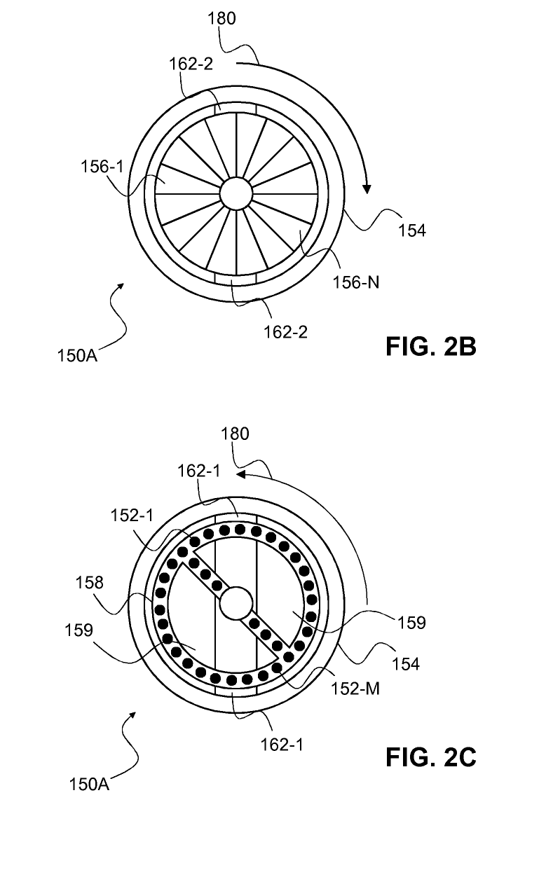

FIG. 3 is a schematic diagram showing a further example of a build material cleaning structure 150B for use in the system 10 of FIG. 1. According to this example, the build material cleaning structure 150B comprises a transmission mechanism 164 which is located between the rotor assembly 156 and the rotatable head portion 158, and supported a support member 163 spanning an internal diameter of the tubular portion 154. The transmission mechanism 164 is provided to convert at least a fraction of the torque generated by the rotor assembly 156 into an oscillating torque to drive the rotatable head portion 158 and the cleaning element 152 in an oscillating rotary motion. This oscillating rotary motion of the cleaning element 152 reduces the dispersion of build material into the atmosphere and provides more efficient collection of the build material, relative to simple rotary motion.

In a further example, the transmission mechanism 164 may convert at least a fraction of the torque generated by the rotor assembly 156 into a reciprocating force to drive the rotatable head portion and the cleaning element 152 in a reciprocating motion (i.e. reciprocating motion in a direction coaxial with the axis of the cylindrical portion 154). This reciprocating motion further assists in breakup and separation of compacted build material on the surface of the 3D printed article, thereby further improving the efficiency with which the build material can be removed and collected.

It will be appreciated that in further examples the transmission mechanism 164 can be configured to drive the rotatable head portion 158 and cleaning element 152 in any combination of a rotational motion, an oscillating rotational motion and/or a reciprocating motion. In this respect, the motion selected for the cleaning element 152 may be selected depending on the intended use of the build material cleaning structure 150B.

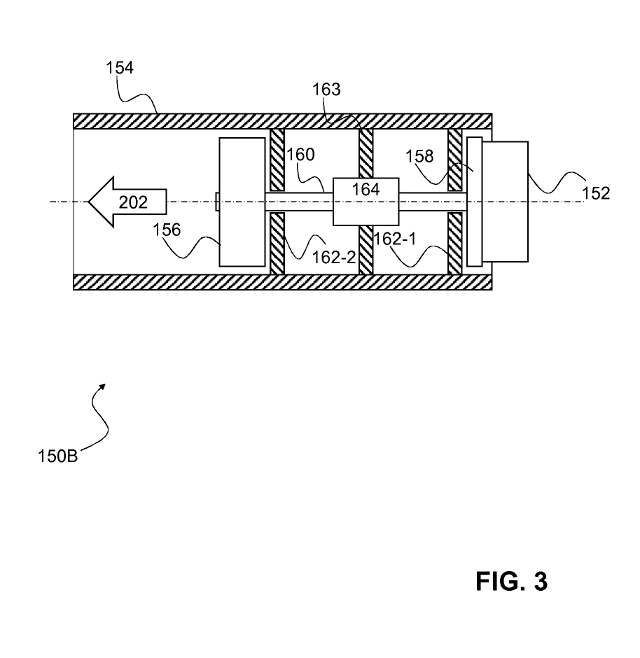

FIG. 4 is a schematic diagram showing a further example of a build material cleaning structure 150C for use in the system 10 of FIG. 1. According to this example, the rotor assembly 156 and the rotatable head portion 158 are directly coupled to each other. This arrangement enables the build material cleaning structure 150C to be provided in a more compact form factor, and reduces the complexity of manufacture. For example, the rotor assembly 156 and the rotatable head portion 152 may be attached to each other using a glue or other suitable retaining material, or formed as a single integral component, thereby reducing the complexity and overall size of the build material cleaning structure 150C. Further, direct coupling between the rotor assembly 146 and the rotatable head portion 152 in this manner enables the length of the shaft 160 to be reduced, thereby leading to a commensurate reduction in the length of the tubular portion 154 needed to house the rotatable head portion 156 and the cleaning element 152.

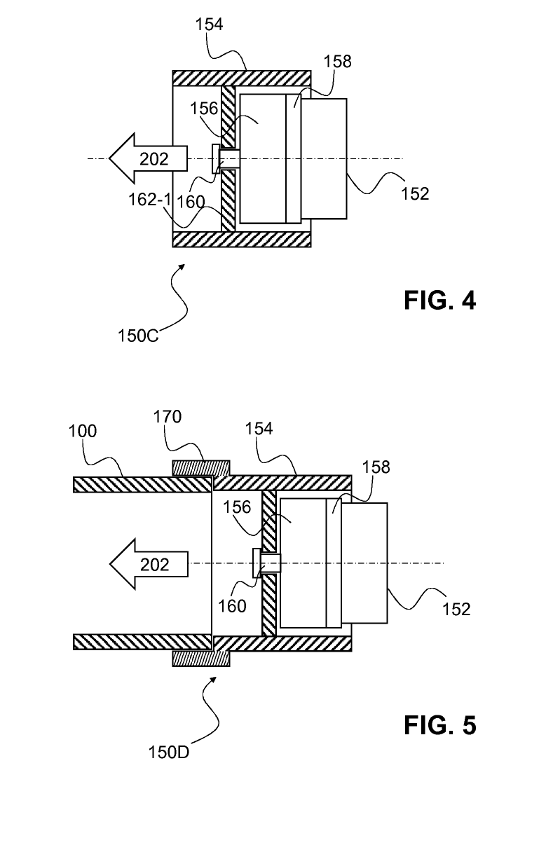

FIG. 5 is a schematic diagram showing a further example of a build material cleaning structure 150D for use in the system 10 of FIG. 1. The build material cleaning structure 150D of FIG. 4 is substantively the same as that shown in FIG. 3 with the addition of a connector portion 170, which is provided to releasably connect the build material cleaning structure 150D to the nozzle structure 100 of the build material management system 10. In this example, the connector portion 170 takes the form of an annular ring which comprises an inner surface to engage a complementary outer surface of the nozzle 100 in an interference fit. In further examples, connector portion 170 may comprise one or more fastening means, such as one or more magnetic elements which are configured to engage with one or more complementary magnetisable elements disposed in the nozzle structure 100, or vice-versa (not shown).

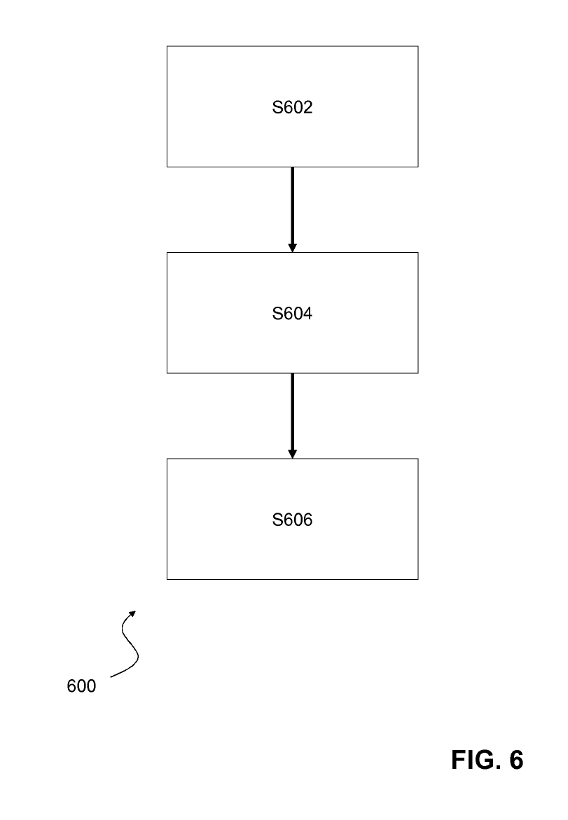

FIG. 6 is a flow diagram showing an example of a method 600 of collecting build material from a 3D printed article. According to this method, an airflow is generated in a nozzle structure 100 to drive a rotatable cleaning element 152 located at least in part within the nozzle structure 100, the rotatable cleaning element being rotatable about an axis that is substantively parallel to the nozzle structure 100 (S602). While the rotatable cleaning element 152 is rotating due to the airflow, it is moved into proximity of the 3D printed article to mechanically agitating the build material and disperse the build material for collection and pneumatic transport through the nozzle structure in the airflow (S604). As the build material has been aspirated into the nozzle structure, it is pneumatically transported to a build material storage apparatus in the generated airflow (S606).

In further examples, the cleaning element 152 may comprise one or more sponge elements or cloth elements in addition to or in replacement of the one or more filament bundles 152-M shown in FIG. 2C. Moreover, the cleaning elements may be formed from any suitable polymer material, such as silicone. Similarly, the one of more filament bundles 152-M shown in FIG. 2C may comprise one or more human hairs, animal hairs, synthetic hairs, or a combination therefore.

The cleaning element 152 or parts of the cleaning element may be replaceable (e.g. in response to normal wear and tear) to ensure that the build material cleaning structure 150 may be used over an extended period of time.

This description is not intended to be exhaustive or to limit these principles to any precise form disclosed. Many modifications and variations are possible in light of the above teaching.

What is claimed is:

1. A build material cleaning structure for use in an additive manufacturing system, comprising:
a tubular portion defining a channel to pneumatically transport a build material;
a rotatable head portion located at least in part within the tubular portion and comprising a cleaning element extending away from an open end of the tubular portion; and
a rotor assembly located within the tubular portion and mechanically coupled to the rotatable head portion to generate a torque to drive the rotatable head portion in a rotary motion in response to an airflow in the channel;
wherein the rotatable head portion is rotatable in a plane that is substantively orthogonal to the airflow in the channel.

2. The build material cleaning structure of claim 1, wherein the rotatable head portion and the rotor assembly are directly coupled.

3. The build material cleaning structure of claim 1, wherein the rotatable head portion and the rotor assembly are coupled by a shaft.

4. The build material cleaning structure of claim 1, wherein the rotor assembly and the rotatable head portion are coupled by a transmission mechanism which converts the torque generated by the rotor assembly into a oscillating torque to drive the rotatable head portion in an oscillating rotary motion.

5. The build material cleaning structure of claim 1, wherein the rotor assembly and the rotatable head portion are coupled by a transmission mechanism which converts the torque generated by the rotor assembly into a reciprocating force to drive the rotatable head portion in a reciprocating motion.

6. The build material cleaning structure of claim 1, wherein the rotor assembly comprises a plurality of turbine blades to generate the torque in response to the airflow in the channel.

7. The build material cleaning structure of claim 1, wherein at least a portion of the cleaning element extends away from the open end of the tubular portion in a direction substantively parallel with an axis of the tubular portion.

8. The build material cleaning structure of claim 1, wherein the rotatable head portion comprises one of more openings to allow pneumatic transport of the build material through the rotatable head portion into the channel.

9. The build material cleaning structure of claim 1, wherein the cleaning element comprises a plurality of resilient filaments.

10. The build material cleaning structure of claim 9, wherein the plurality of resilient filaments are retained by the rotatable head portion in a bundle.

11. The build material cleaning structure of claim 9, wherein the plurality of resilient filaments are nylon filaments.

12. The build material cleaning structure of claim 9, wherein the plurality of resilient filaments comprise an anti-static agent or material.

13. The build material cleaning structure of claim 1, comprising a connector portion to releasable connect the build material cleaning attachment to a nozzle structure.

14. A build material management system, comprising:
a nozzle structure comprising an open end and providing a channel to pneumatically transport a build material;
a vacuum source to generate an airflow in the channel to draw the build material into the channel through the open end of the nozzle structure;
a rotatable cleaning element located at least in part within the nozzle structure and extending away from the open end of the nozzle structure, the rotatable cleaning element being rotatable about an axis that is substantively parallel to an axis of the nozzle structure; and
an aerodynamic element located at least in part within the channel to rotate the rotatable cleaning element in response the airflow;
wherein the rotatable cleaning element is configured to mechanically agitate build material for pneumatic transport in the channel.

15. A method of collecting build material, the method comprising:
generating an airflow in a nozzle structure to drive a rotatable cleaning element located at least in part within the nozzle structure, the rotatable cleaning element being rotatable about an axis that is substantively parallel to an axis of the nozzle structure;
mechanically agitating a build material using the rotatable cleaning element to disperse the build material for pneumatic transport through the nozzle structure in the airflow; and
transporting the dispersed build material from the nozzle to a build material storage apparatus using the airflow.
